(19) United States
(12) Patent Application Publication
(10) Pub. No.: US 2012/0188501 A1
(43) Pub. Date: Jul. 26, 2012

(54) EYEGLASS TEMPLE INSERT AND ASSEMBLY

(76) Inventors: Lewis Page Johnson, Lebanon, OH (US); Sidney Meade Harrison, JR., Chester, VA (US)

(21) Appl. No.: 13/014,449

(22) Filed: Jan. 26, 2011

(51) Int. Cl. G02C 11/00

(52) U.S. Cl. 351/158

(57) ABSTRACT

The present invention provides an eyeglass assembly including an eyeglass temple having a cavity portion and a temple insert, which fittingly engages the cavity portion. The temple insert includes a chamber having an inner portion for holding elements. The temple insert also includes a flange portion disposed at a bottom end of the exterior of the chamber and extending outward therefrom. The flanges assist in the contacting engagement of the insert with the temple. Disposed within the chamber are elements including a power source and a wireless transmitter. The transmitter is powered by the power source and operative to transmit a wireless signal from the chamber.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to eyeglasses and more specifically to the inclusion of electronics and assemblies within eyeglass temples.

### BACKGROUND OF THE INVENTION

There are limited advancements regarding eyeglass technology relating to the frames and temples. Typical designs relate to styles of the eyewear, including frames for holding lenses and temple designs. But regarding inclusion of electronics or technology, there are limited advancements.

Common examples include a brand of eyeglasses that include electronics clipped to the outside of the temple. Common designs are described in U.S. Pat. No. 7,682,018, which include the description of the exterior clip to the eyewear.

These current designs are limited as being not only aesthetically displeasing, but also large and obtrusive. The designs for placing electronics on eyeglass temples include the placement of these electronics exposed as a stand-alone component. These require design limitations for the eyeglass temple, as we all providing inferior design for possibly damaging the electronics.

The eyeglass temples must have a narrow width so the external component can be clamped on. This limits any design features for the temple to this narrow construction. The design is also limited because room must be provided so the electronics capsule can comfortably extend out from the frame.

From an electronics design perspective, there are specific flaws by having the electronics so exposed. The prior art eyeglasses are primarily geared for sporting activities, including the ability for a person to listen to music, talk on a phone, etc., while doing a particular activity. The disposition of the electronics extending out from the temple exposes the electronics and subjects them to possible damage. Damage can be from the elements, i.e. rain, sweat, external moisture, etc. Additionally, exposure of the elements can subject them to getting broken based on the eyeglasses being dropped or the wearer bumping them during activities.

Beyond the external disposition of electronics on eyeglasses, other techniques include placing electronics in hands-free ear-piece components, such as blue-tooth wireless ear pieces. These pieces are separate from the eyewear, unless connected directly to the eyewear temple, but again suffer from the same limitations. They are clunky and aesthetically displeasing. Moreover, the existing technology for eyewear assemblies are directed to allowing a user to listen to music, so the electronics are directed to transmitting signals to ear pierces via the eyeglass temple, whereby the temple is also designed to require the earpiece component to be included therewith.

As such, there exists a need for an improved eyeglass assembly and temple component(s) that includes the placement of electronics up into the eyeglass without exposing the elements to damage.

### SUMMARY OF THE INVENTION

The present invention provides an eyeglass assembly including an eyeglass temple having a cavity portion and a temple insert that fittingly engages the cavity portion. The temple insert includes a chamber having an inner portion for holding the elements. The temple insert also includes a flange portion disposed at a bottom end of the exterior of the chamber and extending outward therefrom. The flange assists in the contacting engagement of the insert with the temple. Disposed within the chamber are elements including a power source and a wireless transmitter. The power source powers the transmitter and the transmitter is operative to transmit a wireless signal from the chamber.

Additional embodiments of the present invention include additional variations of functionality with the temple insert. One embodiment includes the insertion of additional elements within the chamber of the insert, including a memory component and processing functionality for reading and/or writing to the memory component. Another embodiment includes the insertion of a global positioning system or other type of location identifier in the temple insert.

In another embodiment, the temple insert may further include a camera and/or microphone therein. The inclusion of the camera and/or microphone allows for the observation of audio and/or video. Inclusion of a memory device can include the recordation of the observations thereon, wherein in another embodiment the wireless transmitter may wirelessly direct the observations to a nearby computing device, such as by way of example a smart phone or other type of mobile computing device.

In another embodiment, the temple insert may include additional functionality and interactivity with the eyeglass lenses. For example, one embodiment may include a display generation device for the placement of images onto one or both of the lenses of the eyeglasses.

Through the wireless transmitter and the inclusion of available processing capabilities, the eyeglass temple and insert provides the improved functionality of eyeglass technology without obfuscating the aesthetics of existing eyeglasses by being essentially hidden in the chamber in the temple. Moreover, the positioning of the chamber within the temple allows for interchangeability of functionality of the system without replacement of eyeglasses, rather interchangeability is accomplished with the replacement of temple inserts.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a perspective view of one embodiment of a pair of eyeglasses having a temple insert;

FIG. 2 illustrates a perspective view of the insert and eyeglass temple assembly;

FIG. 3 illustrates one embodiment of a temple insert having a top cover removed with the electronic components visible;

FIGS. 4a and 4b illustrate different embodiments of bottom views of the temple insert;

FIG. 5 illustrates a temple insert with a camera and an engage button;

FIG. 6 illustrates a perspective view of one embodiment of a pair of eyeglasses having the temple insert with a camera; and

FIG. 7 illustrates one embodiment of an eyeglass assembly in wireless communication with a mobile computing device.

### DETAILED DESCRIPTION

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

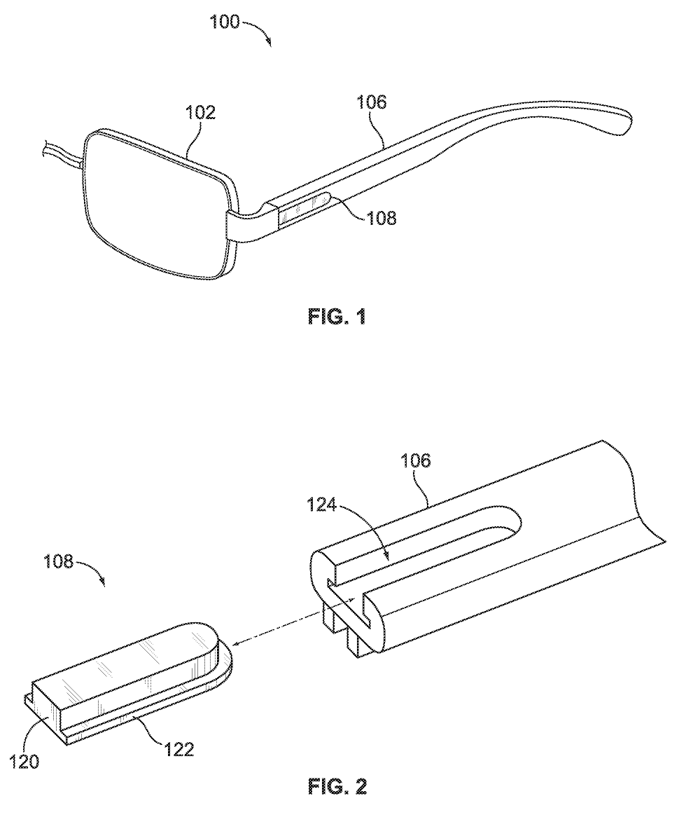

FIG. 1 illustrates one embodiment an eyeglass assembly 100 including a lens 102, frame hinge 104, temple 106 and temple insert 108. The lens 102 and hinge 104 may be any suitable type of lens and hinge as recognized by one skilled in the art.

The temple 106 and the insert 108 have a mating design such that the temple insert 108 can be inserted into the temple 106 when the hinge 104 is open and is secured in place by the closing of the hinge 104. Additionally, the insert 108 has dimensions allowing for the snug or otherwise contacting fit within the temple 106 such that when the hinge 104 is open, e.g. when the glasses are being stored, the insert 108 stays in place.

As visible in FIG. 1, the temple insert 108 aligns within the temple 106. The insert 108 may include components therein, as described in further detail below, but it is also recognized the insert 108 may be a temporary coffin having nothing inside.

FIG. 1 illustrates the exposed surface area on external side of the insert 108. In one embodiment, this exposed area of the insert 108 may include advertising or other types of logos or indicators. For example, a user may select an insert 108 that includes a team logo on the external portion. Whereas when not wanting to sport the team logo, the user can then replace the insert 108 with an insert not having a logo or a different type of logo.

For further illustration of the engagement between the insert 108 and the temple 106, FIG. 2 an exploded view of a portion of the assembly 100 of FIG. 1. The insert 108 includes a chamber 120 and a flange portion 122. Not visible in FIG. 2, the chamber 120 includes an inner portion for holding various elements.

The temple 106 includes a cavity portion 124. In this embodiment, the cavity portion 124 has a mating design for receiving the flange portion 122 and contactingly engaging the insert 108 therein. In the illustrated embodiment of FIG. 2, the chamber 120 and bottom flange both include curved front portions and the cavity 124 includes corresponding curved and recessed portions.

It is recognized that the illustrated curved design is one exemplary design and that other designs are so envisioned and within the scope of the present invention, wherein the insert 108 is fittingly engagement within the temple 106.

As illustrated in FIG. 2, a user can slide 126 the insert 108 into and out of the cavity portion 124 when the temple 106 is in an open position relative to the hinge 104 of FIG. 1. But the closing of the hinge 104 of FIG. 1 provides a backstop against the backside of the insert 108 to hold the insert relative to the cavity 124.

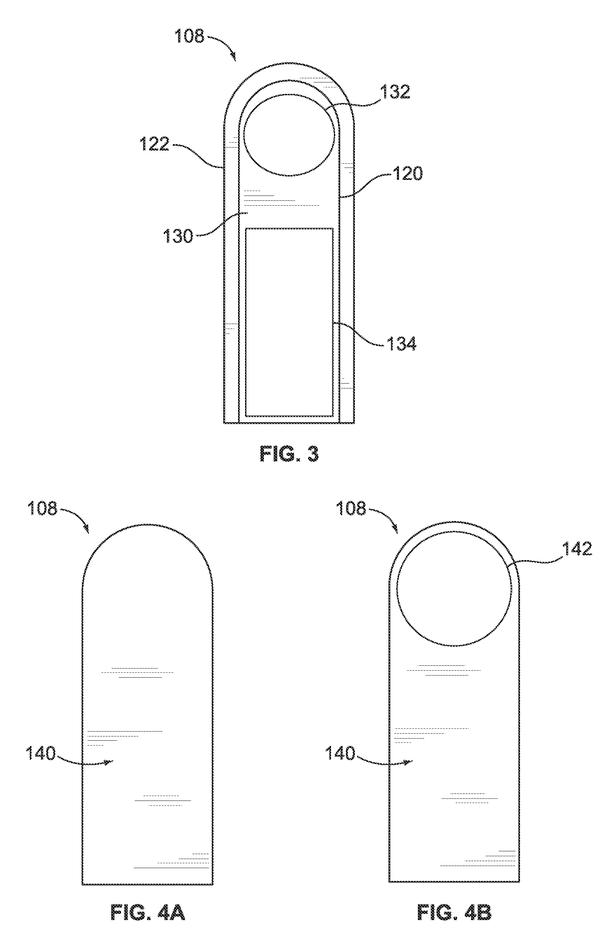

FIG. 3 illustrates one embodiment of the insert 108, illustrated here with a top cover removed to expose internal elements. The insert 108 includes the chamber 120, bottom flange 122. Inside the chamber is the inner portion 130, which in this embodiment, includes a battery 132 and a wireless transmitter 134. These elements may be securely mounted within the inner chamber 130 such that when the top cover (not illustrated) is in place, the elements are secured therein.

The wireless transmitter 134 includes electronic processing components for transmitting a wireless signal including data therein. The transmitter 134 operates in response to power consumption from the battery 132 as its power source. The wireless transmitter can transmit using any suitable wireless transmission, but it is recognized that one embodiment includes a low power, short-range wireless transmission to minimize power consumption and signal interference. For example, the transmitter might transmit using Bluetooth® transmission signals. As described in further detail below, the transmission can be with a corresponding computing device, such as by way of example a mobile phone or other portable computing device.

FIG. 3 illustrates a general representative of one embodiment of the insert 108 and the inner portion 130. The portion 130 may include any number of other processing or electronic elements and is not expressly limited to the wireless transmitter. For example, one embodiment may include a memory device capable of storing information therein. The memory device may be in communication with the wireless transmitter 134 so that a user can store information in the temple insert 108 via a wireless transmission. As an example, medical information may be stored therein.

In another embodiment, the inner portion 130 may include location identifier information, such as a global positioning system receiver or other type of indicator. By way of example, the temple insert 108 may include a location identifier such that when pinged by another device, can determine the location of the glasses, and subsequently the location of the wearer, one example being a child who gets lost or a person suffering from dementia. Another example can be the simple act of using temple functionality to find the eyeglasses when the user misplaces them.

It is recognized that the disposition of processing elements in the insert 108 is not limited to the embodiments described above, but any other suitable elements may be included therein, including for example a microprocessor or other type of computing logic, as well as additional output generation components. Additional embodiments are described in further detail with figures below.

FIG. 4a and FIG. 4b illustrate comparative displays of two different embodiments of bottom portions of the insert 108. FIG. 4a illustrates an encapsulated insert 108 having a smooth bottom portion 140. In this embodiment, the battery source 132 of FIG. 3 is then encased within the insert 108. When the battery expires, in this embodiment, the user can then either replace the insert 108 with a new insert 108, or in another embodiment, the bottom portion 140 may be removable from the bottom flange such as by using a snug-fit engagement. Where the bottom portion 140 can be fully removed, the user can then remove and replace the battery source with a new battery. For example, one embodiment includes the utilization of one or more standard battery sizing's readily available, such as for example batteries commonly found and usable with hearing aid devices.

By contrast, FIG. 4b illustrates an alternative embodiment having a battery chamber 142. In this embodiment, when the insert 108 is not engaged within the temple 106, this chamber 142 is exposed. This embodiment allows for easier access to and replacement of the power source.

Another embodiment may include the power source not being a battery as described above. Rather, the battery may be a rechargeable power source operative to be recharged by any number of means, including a physical plug or wireless transmission of power recharging, as recognized by one skilled in the art.

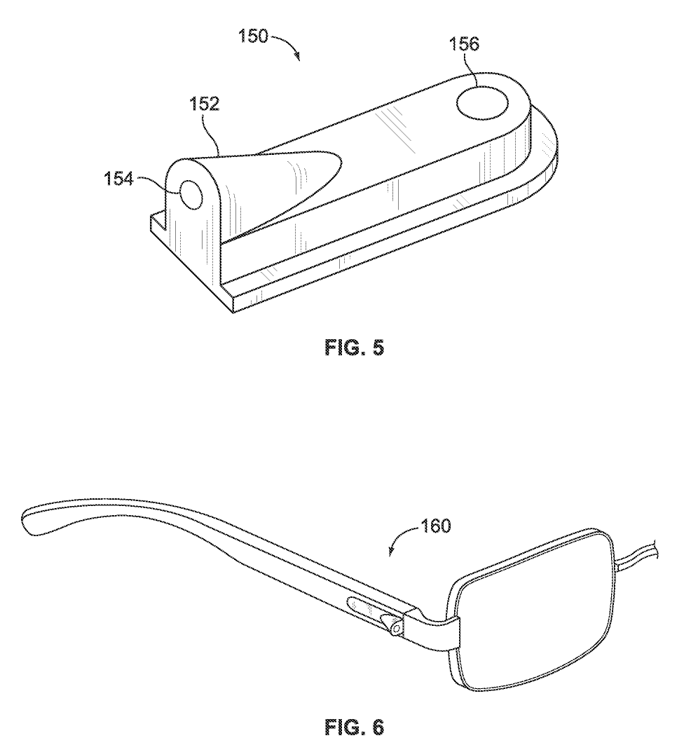

FIG. 5 illustrates one embodiment a temple insert 150 including a protruding portion 152 having a camera lens 154 extending out therefrom. The insert 108 additionally includes an engagement button 156. Similar to the insert 108 described above, the insert 150 contactingly engages the temple in a pair of eyeglasses, such as illustrated in the eyeglass assembly 160 of FIG. 6.

In this embodiment, the temple insert 150 includes the ability for a user to record video content via the camera 154. The camera 154 has a limited protrusion, thereby not affecting the aesthetics of the eyeglass assembly, but providing improved functionality in the eyeglasses. Moreover, another embodiment may include an audio recording device, such as a microphone. In one embodiment, the toggling of the engagement button 156 could enable both the recording of video and audio content. In an embodiment where the inert includes a memory component, the recorded content can be stored therein. Whereas, as noted above, other embodiments includes the direct connection via a wireless connection to a processing device having a greater degree of processing capabilities beyond the temple insert.

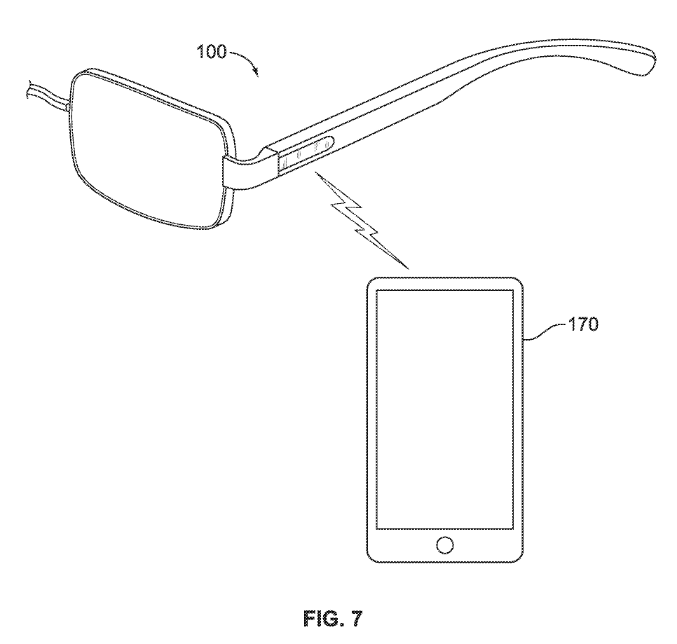

FIG. 7 illustrates the eyeglass assembly 100 in operative communication with a mobile device 170. One embodiment includes low power low range wireless communication, but other wireless techniques are envisioned and within the scope of the eyeglass assembly. Using the example of a data storage device in the insert, a user may write data from a computing device, such as a smart phone, laptop computer, home computer and any other type of processing device. Via the wireless transmission, this data can be stored thereon, such that at a later point in time, the data can be extracted from the memory device to the mobile device 170. An above example was the inclusion of medical information, whereby a doctor, nurse, EMT, pharmacist, or other medical caregiver could access the information.

In another example, the temple insert 150 having the camera 154 may transmit image data to a printing device for printing images thereon or storing images on the mobile device for use at a later point in time. Another embodiment may be the utilization of the camera 160 to provide enhanced video conferencing abilities by transmitting a live image feed from the insert 150 to a mobile device, such that the mobile device 170 can handle the processing and longer-range data transmission. Another embodiment can be the utilization of the insert for the recordation of events minus the requirement of a specific camera or camera equipment for the user, using the eyeglasses instead, and utilizing the wireless connection to provide a greater amount of data storage opportunities. It is recognized that the spacing and battery options are limited in the insert itself, therefore the wireless communication allows for the off-loading of many of the tasks and capabilities, while retaining the benefits of the temple insert and not adversely affecting the aesthetics of the eyeglass temple.

Another embodiment of the invention includes the utilization of a video output display system in conjunction with the insert. The location of the insert provides for the generation of an output display that can be transmitted for display on at least one of the eyeglass lenses. The temple insert may include processing operations for generating an output signal and communication means for activating a display system.

The inclusion of a video display provides an even broader scope of opportunities for data recording. For example, a user can engage in video conferencing using processing capabilities of a mobile computing device, i.e. smart phone, tablet computer, mobile computer, etc. The wireless communication allows for functionality in the temple insert to provide further visual outputs. The user wearing the eyeglasses can transmit to the other party what the user actually sees. The user wearing the eyeglasses could then receive and view on a lens of the eyeglasses what the other person sees or the other person.

As described herein, the inclusion of a temple insert in an eyeglass assembly allows for the placement of electronic functionality in the eyeglasses without detracting from the aesthetics of the eyeglasses themselves. The temple insert is readily removable and interchangeable. Moreover, the temple insert can be on corresponding temples and eyeglass assemblies may include coordinating different inserts on different sides for different functionalities. For example, a left insert may include a camera and a right insert may include a lens-based output display generator. Thereby, the present eyeglass assembly and temple insert overcomes the shortcomings of the prior art, improves upon the functionality for users and provides further electronic integration of eyeglasses without adversely affecting eyeglass aesthetics.

FIGS. 1 through 7 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. An eyeglass temple insert comprising:
a chamber having an inner portion for holding elements therein;
a flange portion disposed at a bottom end of the exterior of the chamber and extending outward therefrom, such that the chamber fittingly engages a receiving portion of an eyeglass temple;
the elements within the chamber portion including:
at least one power source disposed therein; and
a wireless transmitter operative to transmit at least one wireless signal including data therein, the wireless transmitter powered by the at least one power source.

2. The eyeglass temple insert of claim 1 further comprising:
the chamber portion further including a data storage device such that data can be stored thereon and read therefrom via the wireless transmitter.

3. The eyeglass temple insert of claim 1, wherein the power source is enclosed within the chamber, the assembly further comprising:
a removing assembly for displacing a portion of the chamber for replacement of the power source.

4. The eyeglass temple insert of claim 3, wherein the chamber includes a slot portion for engagement of the power source into the slot portion.

5. The eyeglass temple insert of claim 1, the chamber and bottom flange both including curved front portions such that the curved front portions contactingly engage a corresponding recessed portion on the eyeglass temple.

6. The eyeglass temple insert of claim 1, wherein the chamber further includes:
an elevated front portion having a camera lens disposed therein.

7. The eyeglass temple insert of claim 1, wherein the chamber further includes:
a microphone assembly for detecting audio content.

8. The eyeglass temple insert of claim 1, wherein the chamber further includes an elevated front portion having a camera lens disposed therein for detecting video content and a microphone assembly for detecting audio content.

9. The eyeglass temple insert of claim 8 the chamber portion further including a data storage device for recording the video content and the audio content.

10. The eyeglass temple insert of claim 8 wherein the wireless transmitter is operative to wirelessly transmit the video content and the audio content.

11. The eyeglass temple insert of claim 1, the chamber further including:
a top portion having advertising content disposed thereon.

12. The eyeglass temple insert of claim 1, the chamber portion further including a global positioning detecting device for detecting global positioning information.

13. An eyeglass assembly comprising:
an eyeglass temple having a cavity portion; and
a temple insert including:
a chamber having an inner portion for holding elements therein;
a flange portion disposed at a bottom end of the exterior of the chamber and extending outward therefrom, such that the chamber fittingly engages the cavity portion of the eyeglass temple;
the elements within the chamber portion including:
at least one power source disposed therein; and
a wireless transmitter operative to transmit at least one wireless signal including data therein, the wireless transmitter powered by the at least one power source.

14. The eyeglass assembly of claim 13 further comprising:
the chamber portion further including a data storage device such that data can be stored thereon and read therefrom via the wireless transmitter.

16. The eyeglass assembly of claim 13, the chamber and bottom flange of the temple insert both including curved front portions and the cavity portion of the eyeglass temple having a corresponding curved recess portion such that the curved front portions contactingly engage the corresponding recessed portion on the eyeglass temple.

17. The eyeglass assembly of claim 13, wherein the chamber further includes:
an elevated front portion having a camera lens disposed therein.

18. The eyeglass assembly of claim 13, wherein the chamber further includes:
a microphone assembly for detecting audio content.

19. The eyeglass assembly of claim 13, wherein the chamber further includes:
an elevated front portion having a camera lens disposed therein for detecting video content;
a microphone assembly for detecting audio content.

20. The eyeglass assembly of claim 13 further comprising:
a lens secured by the eyeglass assembly;
a display generation device operative to generate a display on the lens; and
a display content distribution device disposed within the chamber operative to provide display content to the display generation device for display on the lens.

21. The eyeglass assembly of claim 13, wherein the wireless transmitter in the chamber is in operative wireless communication with a mobile computing device from data communication therewith.

22. The eyeglass assembly of claim 13, wherein the temple insert is readily removable from the cavity portion of the temple.

23. An eyeglass temple insert comprising:
a chamber having an inner portion for holding elements therein;
a flange portion disposed at a bottom end of the exterior of the chamber and extending outward therefrom, such that the chamber fittingly engages a receiving portion of an eyeglass temple;
the elements within the chamber portion including:
at least one power source disposed therein;
a wireless transmitter operative to transmit at least one wireless signal including data therein, the wireless transmitter powered by the at least one power source;
an elevated front portion having a camera lens disposed therein for detecting video content via a camera;
a microphone assembly for detecting audio content via a microphone; and
a toggle button disposed on the exterior of the temple insert for starting or stopping at least one of the camera and microphone.

24. The eyeglass temple insert of claim 23 the chamber portion further including a data storage device for recording the video content and the audio content.

25. The eyeglass temple insert of claim 23 wherein the wireless transmitter is operative to wirelessly transmit the video content and the audio content.
